(19) United States
(12) Patent Application Publication
(10) Pub. No.: US 2023/0176384 A1
(43) Pub. Date: Jun. 8, 2023

(54) PROJECTION GLASSES, WEARABLE PROJECTION APPARATUS, AND FOLDABLE OPTICAL ENGINE

(71) Applicant: MEGAFORCE COMPANY LIMITED, NEW TAIPEI CITY (TW)

(72) Inventors: CHIH-HAN YEN, NEW TAIPEI CITY (TW); YU-YI CHIEN, NEW TAIPEI CITY (TW); KEN-WANG CHENG, NEW TAIPEI CITY (TW)

(21) Appl. No.: 17/946,005

(22) Filed: Sep. 15, 2022

Related U.S. Application Data
(60) Provisional application No. 63/286,290, filed on Dec. 6, 2021.

(30) Foreign Application Priority Data
Jul. 11, 2022 (TW) 111125839

(51) Int. Cl. G02B 27/01

(52) U.S. Cl. CPC G02B 27/0176; G02B 27/0172; G02B 2027/0154; G02C 5/22

(57) ABSTRACT

A pair of projection glasses, a wearable projection apparatus, and a foldable optical engine are provided. The foldable optical engine includes a projection mechanism and a light emitting mechanism. A light input portion of the projection mechanism corresponds in position to a light output portion of the light emitting mechanism. The projection mechanism and the light emitting mechanism are pivotally connected to each other along a rotation axis so as to be rotatable relative to each other along the rotation axis. When the projection mechanism and the light emitting mechanism are rotated relative to each other to cause the light output portion to face toward the light input portion, the light emitting mechanism is configured to emit a light beam from the light output portion toward the light input portion, so as to allow the projection mechanism to receive the light beam for projecting an image light.

### CROSS-REFERENCE TO RELATED PATENT APPLICATION

This application claims the benefit of priority to Taiwan Patent Application No. 111125839, filed on Jul. 11, 2022. The entire content of the above identified application is incorporated herein by reference.

This application claims the benefit of priority to the U.S. Provisional patent application Ser. No. 63/286,290 filed on Dec. 6, 2021, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical engine for projection, and more particularly to a pair of projection glasses, a wearable projection apparatus, and a foldable optical engine.

### BACKGROUND OF THE DISCLOSURE

A pair of conventional projection glasses (e.g., a pair of augmented reality glasses) includes a frame, two temples connected to the frame, and an optical engine. The optical engine is fixed to a corner area located between the frame and one of the two temples, however, such limitation of a position of the optical engine causes a front part of the conventional projection glasses to have a large volume.

### SUMMARY OF THE DISCLOSURE

In response to the above-referenced technical inadequacy, the present disclosure provides a pair of projection glasses, a wearable projection apparatus, and a foldable optical engine to effectively improve on the issues associated with conventional optical engines.

In one aspect, the present disclosure provides a pair of projection glasses, which includes a frame, at least one lens fixed to the frame, two temples, and a foldable optical engine. The two temples are pivotally connected to two end portions of the frame, respectively. One of the two temples is defined as a functional temple and is rotatable relative to the frame along a rotation axis between a wearing position and a folded position. The foldable optical engine includes a projection mechanism and a light emitting mechanism. The projection mechanism is fixed to the frame and is arranged adjacent to the at least one lens. The projection mechanism has a light input portion. The light emitting mechanism is fixed to the functional temple and has a light output portion that corresponds in position to the light input portion. The light emitting mechanism is rotatable relative to the projection mechanism along the rotation axis. When the functional temple is located at the wearing position, the light emitting mechanism is configured to emit a light beam from the light output portion toward the light input portion, so as to allow the projection mechanism to receive the light beam for projecting an image light into the at least one lens.

In another aspect, the present disclosure provides a wearable projection apparatus, which includes a wearable member, a lens corresponding in position to the wearable member, and a foldable optical engine. The foldable optical engine includes a projection mechanism and a light emitting mechanism. The projection mechanism is fixed to the lens and has a light input portion. The light emitting mechanism is fixed to the wearable member and has a light output portion that corresponds in position to the light input portion. The projection mechanism is pivotally connected to the light emitting mechanism along a rotation axis, so that the lens and the projection mechanism are jointly rotatable relative to the light emitting mechanism along the rotation axis between an operation position and a non-operation position. When the lens and the projection mechanism are located at the operation position, the light emitting mechanism is configured to emit a light beam from the light output portion toward the light input portion, so as to allow the projection mechanism to receive the light beam for projecting an image light into the lens.

In yet another aspect, the present disclosure provides a foldable optical engine, which includes a projection mechanism and a light emitting mechanism. The projection mechanism has a light input portion. The light emitting mechanism has a light output portion corresponding in position to the light input portion. The projection mechanism is pivotally connected to the light emitting mechanism along a rotation axis, so that the projection mechanism and the light emitting mechanism are rotatable relative to each other along the rotation axis. When the projection mechanism and the light emitting mechanism are rotated relative to each other to cause the light output portion to face toward the light input portion, the light emitting mechanism is configured to emit a light beam from the light output portion toward the light input portion, so as to allow the projection mechanism to receive the light beam for projecting an image light.

Therefore, in the projection glasses or the wearable projection apparatus provided by the present disclosure, the foldable optical engine can be assembled in a flexible manner through structural designs thereof (e.g., the light emitting mechanism being rotatable relative to the projection mechanism along the rotation axis), and the foldable optical engine can be applied to different wearable members (e.g., a pair of glasses or a hat) through structural configurations thereof.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of a pair of projection glasses at a wearing position according to a first embodiment of the present disclosure;

FIG. 2 is a planar cross-sectional view of FIG. 1;

FIG. 3 is an enlarged view of FIG. 2;

FIG. 4 is a perspective view of the projection glasses at a folded position according to the first embodiment of the present disclosure;

FIG. 5 is an enlarged view of part V of FIG. 4;

FIG. 6 is a perspective view showing a foldable optical engine and a shaft of the projection glasses of FIG. 1 at the wearing position according to the first embodiment of the present disclosure;

FIG. 7 is a perspective view showing the foldable optical engine and the shaft of FIG. 6 from another viewing angle;

FIG. 8 is a perspective view showing the foldable optical engine and the shaft of the projection glasses of FIG. 4 at the folded position according to the first embodiment of the present disclosure;

FIG. 9 is a perspective view showing the foldable optical engine and the shaft of FIG. 8 from another angle of view;

FIG. 10 is a schematic view of a wearable projection apparatus at an operation position according to a second embodiment of the present disclosure;

FIG. 11 is a schematic view of the wearable projection apparatus at a non-operation position according to the second embodiment of the present disclosure; and

FIG. 12 is a perspective view showing a part of FIG. 11.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

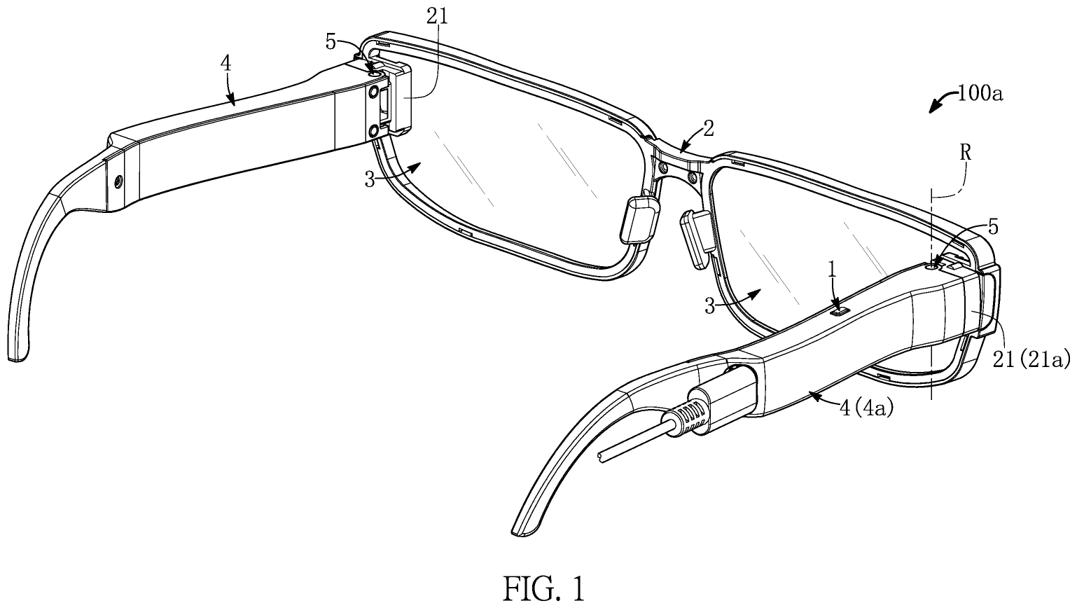

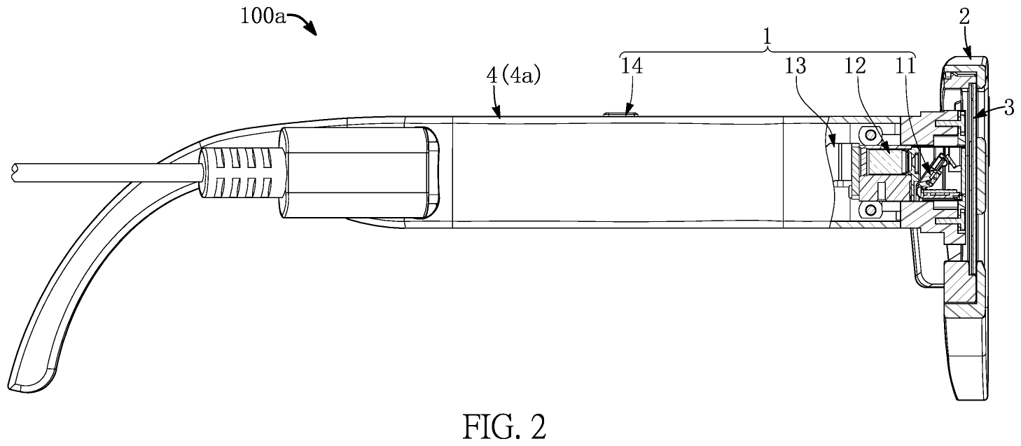

Referring to FIG. 1 to FIG. 9, a first embodiment of the present disclosure provides a pair of projection glasses 100a that can be a pair of augmented reality (AR) glasses, but the present disclosure is not limited thereto. As shown in FIG. 1 to FIG. 5, the projection glasses 100a in the present embodiment includes a frame 2, two lenses 3 fixed to the frame 2, two temples 4 respectively and pivotally connected to two end portions 21 of the frame 2, and a foldable optical engine 1.

It should be noted that the projection glasses 100a in the present embodiment is described by the above components, but the present disclosure is not limited thereto. For example, in other embodiments of the present disclosure, the two lenses 3 of the projection glasses 100a can be connected to each other so as to be regarded as one lens 3 fixed to the frame 2; or, the foldable optical engine 1 can be independently used (e.g., sold) or can be used in cooperation with other components.

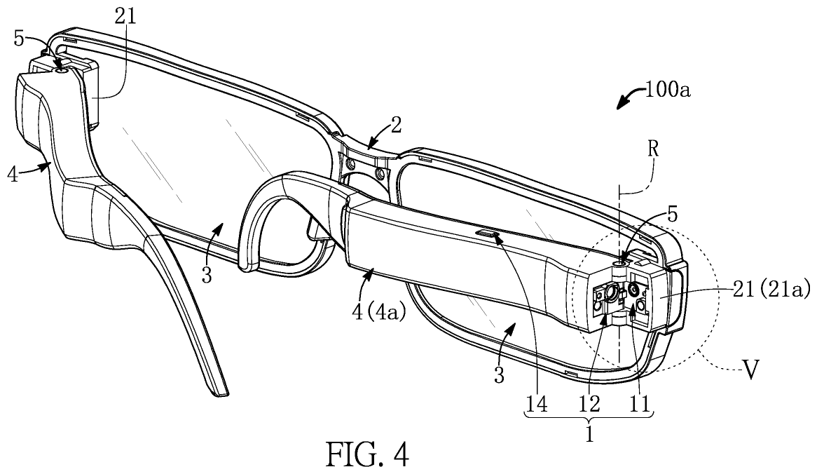

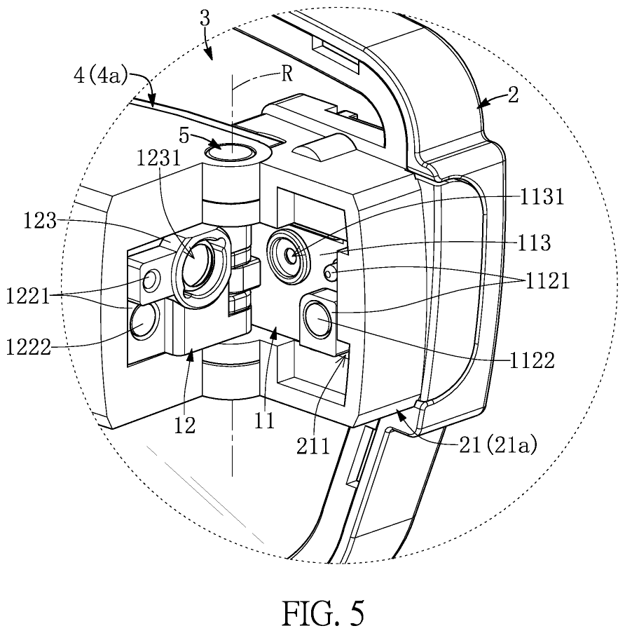

Moreover, each of the two temples 4 is rotatable relative to the frame 2 along a rotation axis R between a wearing position (as shown in FIG. 1 to FIG. 3) and a folded position (as shown in FIG. 4 and FIG. 5). The projection glasses 100a in the present embodiment includes two shafts 5 respectively inserted into the two temples 4, so that the two temples 4 are pivotally connected to the two end portions 21 of the frame 2 along the rotation axis R, respectively, but the present disclosure is not limited thereto. For example, in other embodiments of the present disclosure, each of the two temples 4 can be directly and pivotally connected to the corresponding end portion 21 of the frame 2 along the rotation axis R without using the shaft 5, such that the corresponding shaft 5 can be omitted.

In addition, in order to clearly describe the present embodiment, one of the two temples 4 (e.g., the temple 4 shown at the right side of FIG. 1) is defined as a functional temple 4a, the end portion 21 connected to the functional temple 4a is defined as a functional end portion 21a, and the foldable optical engine 1 is assembled to the functional temple 4a and the functional end portion 21a.

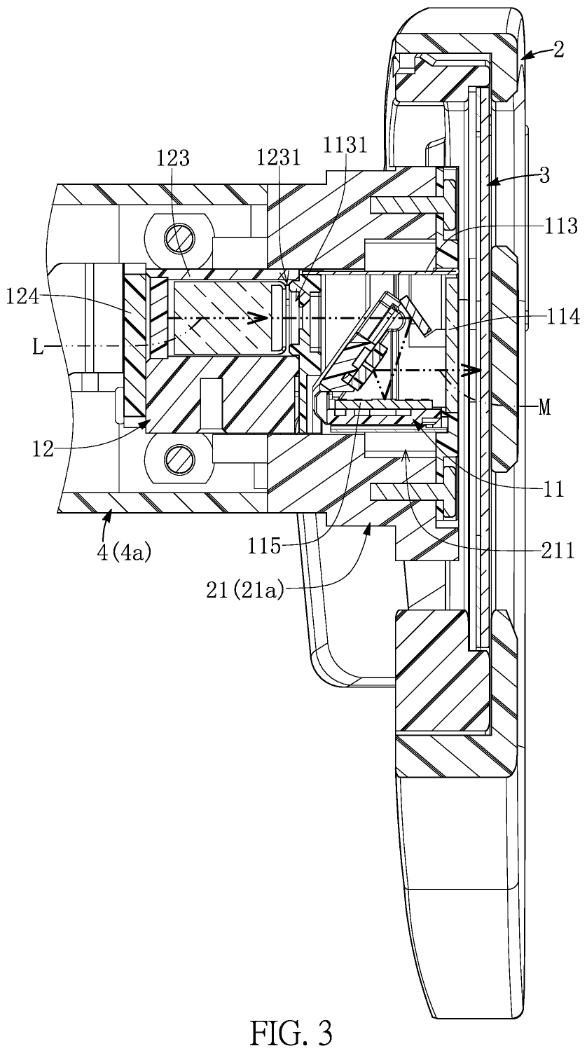

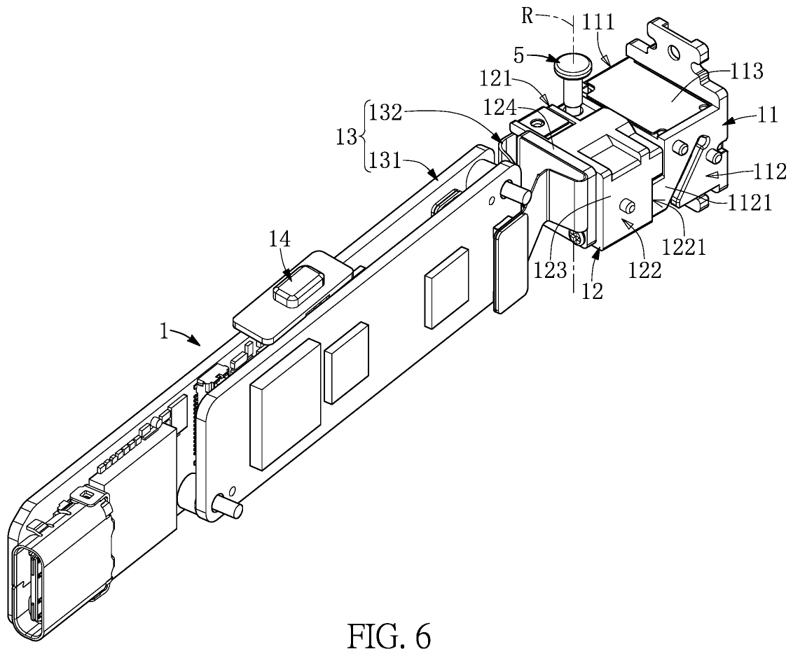

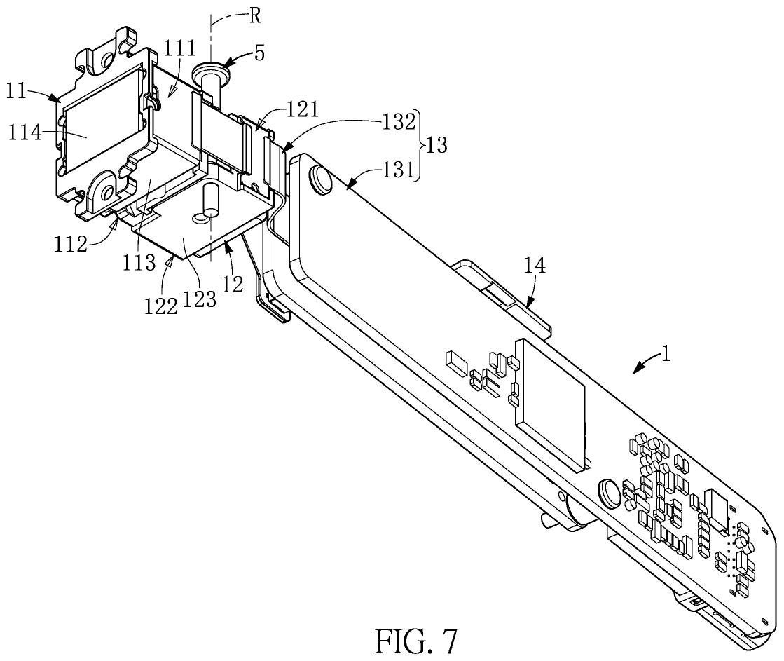

As shown in FIG. 3, FIG. 6, and FIG. 7, the foldable optical engine 1 includes a projection mechanism 11, a light emitting mechanism 12 corresponding in position to the projection mechanism 11, a circuit module 13 electrically coupled to the projection mechanism 11 and the light emitting mechanism 12, and a switch unit 14 that is assembled to the circuit module 13. The projection mechanism 11 is fixed to the frame 2 (e.g., the functional end portion 21a) and is arranged adjacent to at least one of the two lenses 3, and the light emitting mechanism 12, the circuit module 13, and the switch unit 14 are assembled to the functional temple 4a.

Specifically, one of the two end portions 21 of the frame 2 (e.g., the functional end portion 21a) has an accommodating slot 211. The projection mechanism 11 is engaged in the accommodating slot 211, and the projection mechanism 11 does not protrude from the accommodating slot 211. The projection mechanism 11 in the present embodiment includes a front housing 113, a light permeable board 114 assembled to the front housing 113, and a micro-electro-mechanical systems (MEMS) module 115 that is assembled in the front housing 113, but the present disclosure is not limited thereto.

The front housing 113 is engaged and fixed in the accommodating slot 211 and has a light input portion 1131 that is arranged adjacent to an opening of the accommodating slot 211. The light permeable board 114 is disposed on one side of the front housing 113 away from the light input portion 1131. In other words, the light input portion 1131 and the light permeable board 114 are respectively located at two opposite sides of the front housing 113, and the light permeable board 114 is arranged adjacent to at least one of the lenses 3.

Moreover, the MEMS module 115 is located between the light input portion 1131 and the light permeable board 114, so that the MEMS module 115 can output an image light M from the light permeable board 114 by transforming a light L that enters into the projection mechanism 11 from the light input portion 1131. In other embodiments of the present disclosure not shown in the drawings, interior components of the MEMS module 115 can be adjusted or changed according to design requirements; or, the MEMS module 115 can be replaced by other modules according to design requirements.

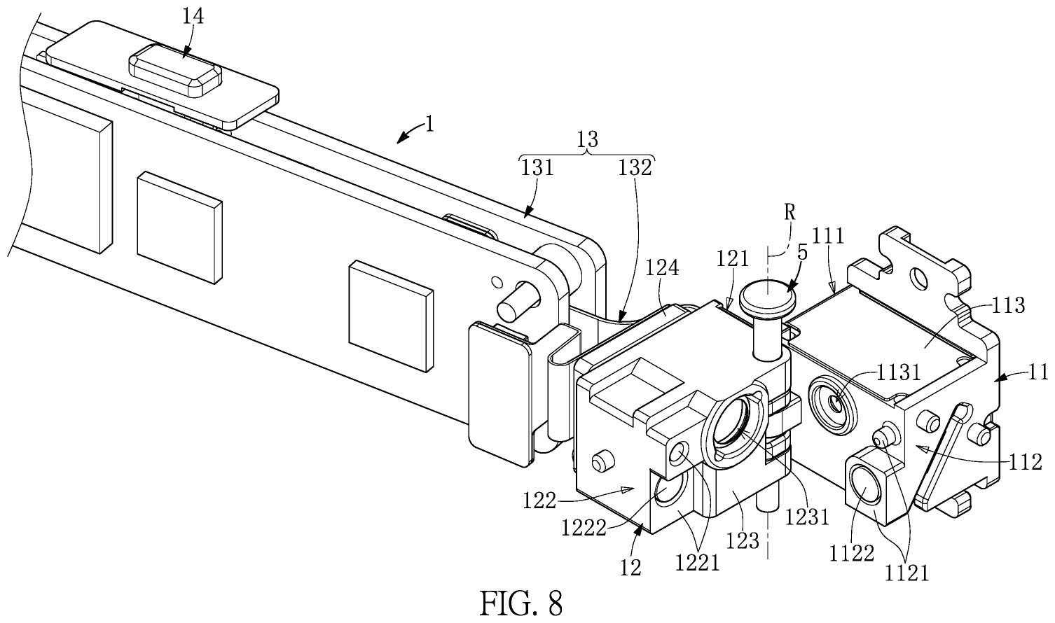

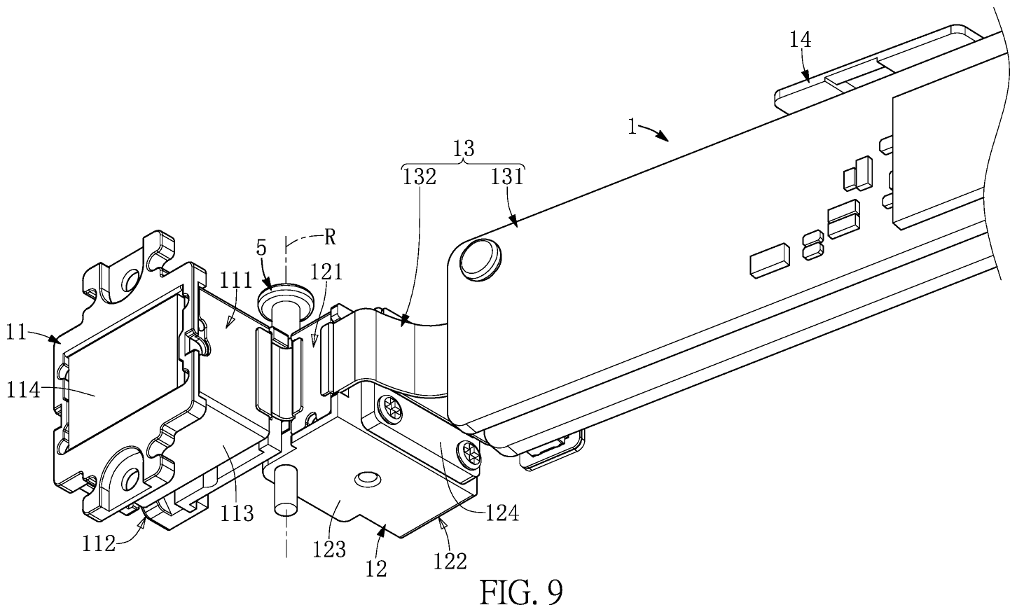

As shown in FIG. 3, FIG. 8, and FIG. 9, the light emitting mechanism 12 is fixed in the functional temple 4a, and the light emitting mechanism 12 in the present embodiment includes a rear housing 123 and a light emitter 124 that is assembled to the rear housing 123. The rear housing 123 is engaged in the functional temple 4a and has a light output portion 1231 corresponding in position to the light input portion 1131, and the light emitter 124 is assembled to one side of the rear housing 123 away from the light output portion 1231.

Moreover, the projection mechanism 11 is pivotally connected to the light emitting mechanism 12 along the rotation axis R, so that the projection mechanism 11 and the light emitting mechanism 12 can be rotatable relative to each other along the rotation axis R. The projection mechanism 11 has a pivotal side 111 and an aligning side 112 respectively arranged at two opposite sides of the light input portion 1131, and the light emitting mechanism 12 has a pivotal side 121 and an aligning side 122 respectively arranged at two opposite sides of the light output portion 1231. The pivotal side 111 of the projection mechanism 11 is pivotally connected to the pivotal side 121 of the light emitting mechanism 12, so that the light emitting mechanism 12 can be rotated relative to the projection mechanism 11 along the rotation axis R.

Specifically, in order to accurately align the light output portion 1231 and the light input portion 1131 with each other when the light emitting mechanism 12 and the projection mechanism 11 are rotated relative to each other, the aligning side 112 of the projection mechanism 11 and the aligning side 122 of the light emitting mechanism 12 preferably and respectively include a plurality of convex-concave fitting structures 1121, 1221 for being engaged with each other and/or a plurality of magnetic attraction structures 1122, 1222 for being magnetically attracted with each other. The magnetic attraction structures 1122, 1222 can be respectively embedded in the convex-concave fitting structures 1121, 1221, thereby effectively increasing the aligning effect.

When the functional temple 4a is located at the wearing position, the aligning side 112 of the projection mechanism 11 abuts against the aligning side 122 of the light emitting mechanism 12, and the light output portion 1231 and the light input portion 1131 can be accurately aligned with each other through the convex-concave fitting structures 1121, 1221 engaged with each other and/or the magnetic attraction structures 1122, 1222 magnetically attracted with each other.

In addition, when the functional temple 4a is located at the folded position, the aligning side 112 of the projection mechanism 11 is separate from the aligning side 122 of the light emitting mechanism 12; in other words, the convex-concave fitting structures 1121, 1221 are separate from each other, and the magnetic attraction structures 1122, 1222 are separate from each other.

Accordingly, when the functional temple 4a is located at the wearing position (or, when the projection mechanism 11 and the light emitting mechanism 12 are rotated relative to each other to cause the light output portion 1231 to face toward the light input portion 1131), the light emitting mechanism 12 (e.g., the light emitter 124) is configured to emit a light beam L from the light output portion 1231 toward the light input portion 1131, so as to allow the projection mechanism 11 (e.g., the MEMS module 115) to receive the light beam L for projecting an image light M from the light permeable board 114 into at least one of the two lenses 3.

It should be noted that the projection mechanism 11 and the light emitting mechanism 12 in the present embodiment are pivotally connected to each other by using one of the two shafts 5 that pivotally connects the functional end portion 21a and the functional temple 4a, thereby effectively reducing the possibility of relative movement between the projection mechanism 11 and the functional end portion 21a, and the possibility of relative movement between the light emitting mechanism 12 and the functional temple 4a. In other words, the pivotal side 111 of the projection mechanism 11 is pivotally connected to the pivotal side 121 of the light emitting mechanism 12 through one of the two shafts 5, but the present disclosure is not limited thereto.

For example, in other embodiments of the present disclosure not shown in the drawings, the projection mechanism 11 and the light emitting mechanism 12 are not connected to (or not in contact with) each other and are moved by the functional end portion 21a and the functional temple 4a, respectively; or, the projection mechanism 11 and the light emitting mechanism 12 can be directly formed to have structures that are pivotally connected to each other, so that the corresponding shaft 5 can be omitted.

In addition, the circuit module 13 is disposed in the functional temple 4a, and the circuit module 13 in the present embodiment includes a circuit board unit 131 and a bendable transmission cable 132 that is assembled to the circuit board unit 131. The circuit board unit 131 is electrically coupled to the light emitting mechanism 12, and the circuit board unit 131 in the present embodiment is a cable connector (not labeled) that is connected to the light emitter 124 for establishing an electrical connection therebetween, but the present disclosure is not limited thereto. For example, in other embodiments of the present disclosure not shown in the drawings, the light emitter 124 can be directly assembled to the circuit board unit 131.

Moreover, the bendable transmission cable 132 is connected to the pivotal side 111 of the projection mechanism 11 by being placed along the pivotal side 121 of the light emitting mechanism 12 and across the rotation axis R. In other words, when the functional temple 4a is rotated between the wearing position and the folded position, the bendable transmission cable 132 is synchronously bent.

The switch unit 14 is assembled to the circuit board unit 131 so as to be electrically coupled to the projection mechanism 11 and the light emitting mechanism 12. The switch unit 14 is triggerable to drive the light emitting mechanism 12 and the projection mechanism 11 when the functional temple 4a is located at the wearing position. Specifically, the triggering manner of the switch unit 14 can be adjusted or changed according to design requirements, and the switch unit 14 in the present embodiment is not limited to a specific type. In other words, the switch unit 14 can be a button, a trigger, a sensor, a wireless controller, or other components.

### Second Embodiment

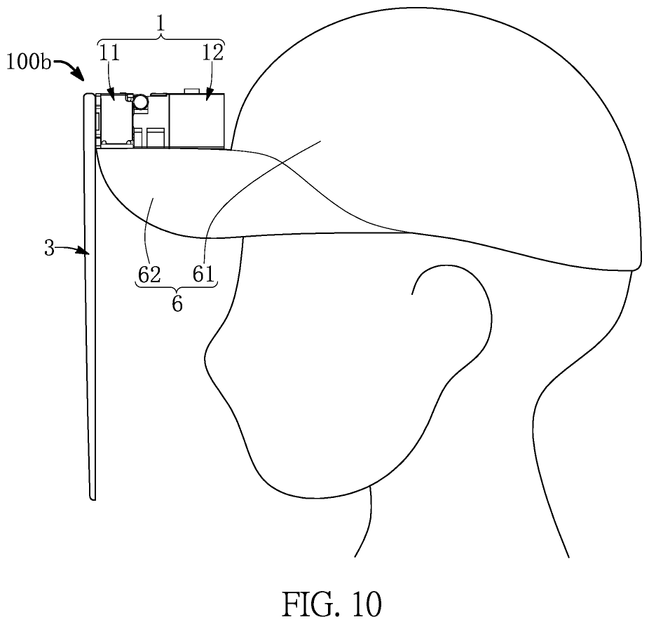

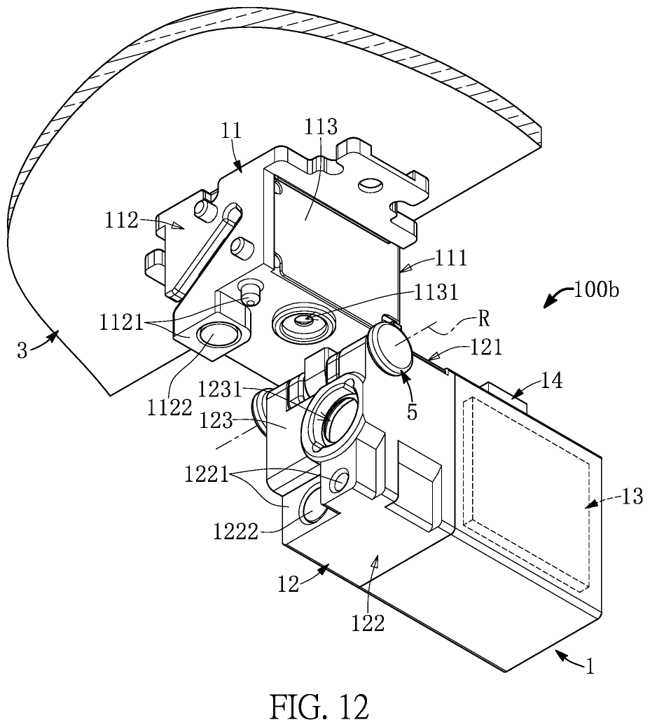

Referring to FIG. 10 to FIG. 12, a second embodiment of the present disclosure is provided, which is similar to the first embodiment of the present disclosure. For the sake of brevity, descriptions of the same components in the first and second embodiments of the present disclosure will be omitted herein, and the following description only discloses different features between the first and second embodiments.

The present embodiment provides a wearable projection apparatus 100b, which includes a wearable member 6, a lens 3 corresponding in position to the wearable member 6, and a foldable optical engine 1. The wearable member 6 in the present embodiment includes a hat 61 and a brim 62 that is connected to a front edge of the hat 61, but the present disclosure is not limited thereto.

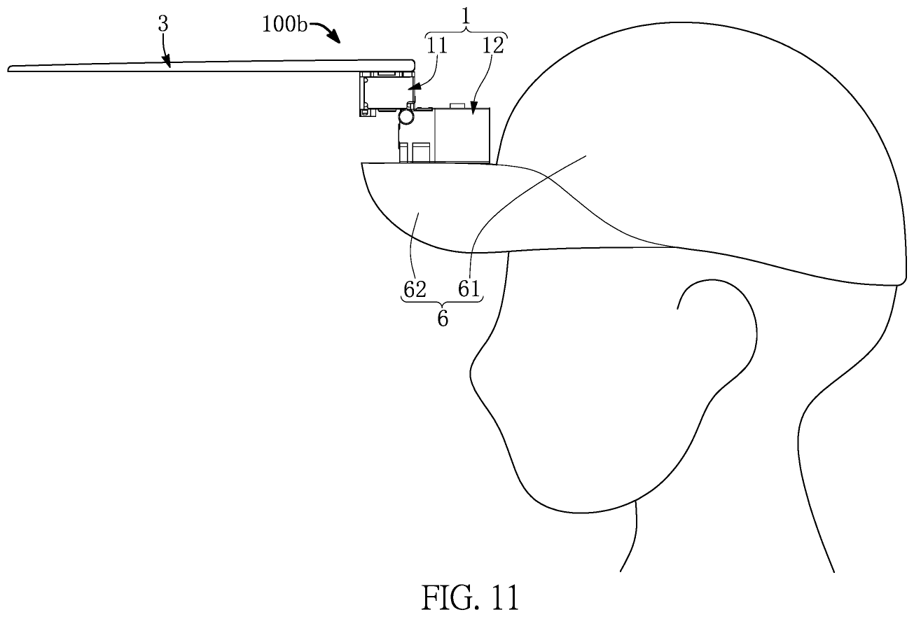

Moreover, a structure of the foldable optical engine 1 of the present embodiment is substantially identical (or similar) to that of the first embodiment, and the following description only describes different features of the foldable optical engine 1 between the first and second embodiments for the sake of brevity. In the present embodiment, the light emitting mechanism 12 of the foldable optical engine 1 is fixed to at least one of the hat 61 and the brim 62, and the projection mechanism 11 is pivotally connected to the light emitting mechanism 12 along the rotation axis R, so that the lens 3 and the projection mechanism 11 can be jointly rotatable relative to the light emitting mechanism 12 along the rotation axis R between an operation position (as shown in FIG. 10) and a non-operation position (as shown in FIG. 11).

It should be noted that the pivotal side 111 of the projection mechanism 11 is pivotally connected to the pivotal side 121 of the light emitting mechanism 12, so that the light emitting mechanism 12 can be rotated relative to the projection mechanism 11 along the rotation axis R. In order to accurately align the light output portion 1231 and the light input portion 1131 with each other when the light emitting mechanism 12 and the projection mechanism 11 are rotated relative to each other, the aligning side 112 of the projection mechanism 11 and the aligning side 122 of the light emitting mechanism 12 preferably and respectively include a plurality of convex-concave fitting structures 1121, 1221 for being engaged with each other and/or a plurality of magnetic attraction structures 1122, 1222 for being magnetically attracted with each other. The magnetic attraction structures 1122, 1222 can be respectively embedded in the convex-concave fitting structures 1121, 1221, thereby effectively increasing the aligning effect.

Accordingly, when the projection mechanism 11 is located at the operation position, the projection mechanism 11 is placed against the brim 62, the aligning side 112 of the projection mechanism 11 abuts against the aligning side 122 of the light emitting mechanism 12, and the light output portion 1231 and the light input portion 1131 can be accurately aligned with each other through the convex-concave fitting structures 1121, 1221 engaged with each other and/or the magnetic attraction structures 1122, 1222 magnetically attracted with each other.

In addition, when the projection mechanism 11 is located at the non-operation position, the projection mechanism 11 is separate from the brim 62, and the aligning side 112 of the projection mechanism 11 is separate from the aligning side 122 of the light emitting mechanism 12; in other words, the convex-concave fitting structures 1121, 1221 are separate from each other, and the magnetic attraction structures 1122, 1222 are separate from each other.

It should be noted that the projection mechanism 11 and the light emitting mechanism 12 in the present embodiment are pivotally connected to each other through one shaft 5, but the present disclosure is not limited thereto. For example, in other embodiments of the present disclosure not shown in the drawings, the projection mechanism 11 and the light emitting mechanism 12 can be directly formed to have structures that are pivotally connected to each other, so that the shaft 5 can be omitted.

In summary, when the lens 3 and the projection mechanism 11 are located at the operation position, the light emitting mechanism 12 is configured to emit a light beam (not shown in the drawings) from the light output portion 1231 toward the light input portion 1131, so as to allow the projection mechanism 11 to receive the light beam for projecting an image light (not shown in the drawings) into the lens 3.

The switch unit 14 of the foldable optical engine 1 is triggerable to drive the light emitting mechanism 12 and the projection mechanism 11 when the projection mechanism 11 is located at the operation position. In the present embodiment, the circuit module 13 can be assembled in the rear housing 123 of the light emitting mechanism 12, and the switch unit 14 is electrically coupled to the projection mechanism 11 and the light emitting mechanism 12 by being assembled to the circuit module 13. Furthermore, the triggering manner of the switch unit 14 can be adjusted or changed according to design requirements, and the switch unit 14 in the present embodiment is not limited to a specific type. In other words, the switch unit 14 can be a button, a trigger, a sensor, a wireless controller, or other components.

### BENEFICIAL EFFECTS OF THE EMBODIMENTS

In conclusion, in the projection glasses or the wearable projection apparatus provided by the present disclosure, the foldable optical engine can be assembled in a flexible manner through structural designs thereof (e.g., the light emitting mechanism being rotatable relative to the projection mechanism along the rotation axis), and the foldable optical engine can be applied to different wearable members (e.g., a pair of glasses or a hat) through a suitable structural configurations thereof.

Moreover, in the foldable optical engine provided by the present disclosure, the light output portion and the light input portion can be accurately aligned with each other through various structural designs (e.g., the convex-concave fitting structures engaged with each other; the magnetic attraction structures magnetically attracted with each other; and the projection mechanism and the light emitting mechanism pivotally connected to each other by sharing one of the two shafts with the functional end portion and the functional temple).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pair of projection glasses, comprising:
a frame;
at least one lens fixed to the frame;
two temples pivotally connected to two end portions of the frame, respectively, wherein one of the two temples is defined as a functional temple and is rotatable relative to the frame along a rotation axis between a wearing position and a folded position; and
a foldable optical engine including:
a projection mechanism fixed to the frame and arranged adjacent to the at least one lens, wherein the projection mechanism has a light input portion; and
a light emitting mechanism fixed to the functional temple and having a light output portion that corresponds in position to the light input portion, wherein the light emitting mechanism is rotatable relative to the projection mechanism along the rotation axis;
wherein, when the functional temple is located at the wearing position, the light emitting mechanism is configured to emit a light beam from the light output portion toward the light input portion, so as to allow the projection mechanism to receive the light beam for projecting an image light into the at least one lens.

2. The projection glasses according to claim 1, wherein the foldable optical engine includes a switch unit electrically coupled to the projection mechanism and the light emitting mechanism, and wherein the switch unit is triggerable to drive the light emitting mechanism and the projection mechanism when the functional temple is located at the wearing position.

3. The projection glasses according to claim 1, wherein the projection mechanism has a pivotal side and an aligning side respectively arranged at two opposite sides of the light input portion, and the light emitting mechanism has a pivotal side and an aligning side respectively arranged at two opposite sides of the light output portion, and wherein the pivotal side of the projection mechanism is pivotally connected to the pivotal side of the light emitting mechanism.

4. The projection glasses according to claim 3, wherein, when the functional temple is located at the wearing position, the aligning side of the projection mechanism abuts against the aligning side of the light emitting mechanism, and wherein, when the functional temple is located at the folded position, the aligning side of the projection mechanism is separate from the aligning side of the light emitting mechanism.

5. The projection glasses according to claim 3, further comprising two shafts, wherein the two shafts are respectively inserted into the two temples, so that the two temples are pivotally connected to the two end portions of the frame, respectively, and wherein the pivotal side of the projection mechanism is pivotally connected to the pivotal side of the light emitting mechanism through one of the two shafts.

6. The projection glasses according to claim 3, wherein the foldable optical engine includes a circuit module disposed in the functional temple and includes:
a circuit board unit electrically coupled to the light emitting mechanism; and
a bendable transmission cable assembled to the circuit board unit, wherein the bendable transmission cable is connected to the pivotal side of the projection mechanism by being placed along the pivotal side of the light emitting mechanism and across the rotation axis;
wherein, when the functional temple is rotated between the wearing position and the folded position, the bendable transmission cable is synchronously bent.

7. The projection glasses according to claim 3, wherein the aligning side of the projection mechanism and the aligning side of the light emitting mechanism respectively include a plurality of convex-concave fitting structures for being engaged with each other.

8. The projection glasses according to claim 3, wherein the aligning side of the projection mechanism and the aligning side of the light emitting mechanism respectively include a plurality of magnetic attraction structures for being magnetically attracted with each other.

9. The projection glasses according to claim 1, wherein one of the two end portions of the frame has an accommodating slot, and the projection mechanism is engaged in the accommodating slot.

10. The projection glasses according to claim 9, wherein the projection mechanism includes:
a front housing engaged in the accommodating slot and having the light input portion;
a light permeable board assembled to the front housing and arranged away from the light input portion, wherein the light permeable board is arranged adjacent to the at least one lens; and
a micro-electro-mechanical system (MEMS) module assembled in the front housing and located between the light input portion and the light permeable board.

11. The projection glasses according to claim 1, wherein the light emitting mechanism includes:
a rear housing engaged in the functional temple and having the light output portion; and
a light emitter assembled to the rear housing and arranged away from the light output portion.

12. A wearable projection apparatus, comprising:
a wearable member;
a lens corresponding in position to the wearable member; and
a foldable optical engine including:
a projection mechanism fixed to the lens and having a light input portion; and
a light emitting mechanism fixed to the wearable member and having a light output portion that corresponds in position to the light input portion, wherein the projection mechanism is pivotally connected to the light emitting mechanism along a rotation axis, so that the lens and the projection mechanism are jointly rotatable relative to the light emitting mechanism along the rotation axis between an operation position and a non-operation position;
wherein, when the lens and the projection mechanism are located at the operation position, the light emitting mechanism is configured to emit a light beam from the light output portion toward the light input portion, so as to allow the projection mechanism to receive the light beam for projecting an image light into the lens.

13. The wearable projection apparatus according to claim 12, wherein the wearable member includes a hat and a brim that is connected to a front edge of the hat, and the light emitting mechanism is fixed to at least one of the hat and the brim, and wherein the projection mechanism is placed against the brim when being at the operation position, and the projection mechanism is separate from the brim when being at the non-operation position.

14. The wearable projection apparatus according to claim 12, wherein the foldable optical engine includes a switch unit electrically coupled to the projection mechanism and the light emitting mechanism, and wherein the switch unit is triggerable to drive the light emitting mechanism and the projection mechanism when the projection mechanism is located at the operation position.

15. The wearable projection apparatus according to claim 12, wherein the projection mechanism has a pivotal side and an aligning side respectively arranged at two opposite sides of the light input portion, and the light emitting mechanism has a pivotal side and an aligning side respectively arranged at two opposite sides of the light output portion, and wherein the pivotal side of the projection mechanism is pivotally connected to the pivotal side of the light emitting mechanism.

16. The wearable projection apparatus according to claim 15, wherein, when the projection mechanism is located at the operation position, the aligning side of the projection mechanism abuts against the aligning side of the light emitting mechanism, and wherein, when the projection mechanism is located at the non-operation position, the aligning side of the projection mechanism is separate from the aligning side of the light emitting mechanism.

17. The wearable projection apparatus according to claim 15, wherein the aligning side of the projection mechanism and the aligning side of the light emitting mechanism respectively include a plurality of convex-concave fitting structures for being engaged with each other.

18. The wearable projection apparatus according to claim 17, wherein the aligning side of the projection mechanism and the aligning side of the light emitting mechanism respectively include a plurality of magnetic attraction structures for being magnetically attracted with each other, and the magnetic attraction structures are respectively embedded in the convex-concave fitting structures.

19. A foldable optical engine, comprising:
a projection mechanism having a light input portion; and
a light emitting mechanism having a light output portion corresponding in position to the light input portion, wherein the projection mechanism is pivotally connected to the light emitting mechanism along a rotation axis, so that the projection mechanism and the light emitting mechanism are rotatable relative to each other along the rotation axis;
wherein, when the projection mechanism and the light emitting mechanism are rotated relative to each other to cause the light output portion to face toward the light input portion, the light emitting mechanism is configured to emit a light beam from the light output portion toward the light input portion, so as to allow the projection mechanism to receive the light beam for projecting an image light.

20. The foldable optical engine according to claim 19, wherein the projection mechanism has a pivotal side and an aligning side respectively arranged at two opposite sides of the light input portion, and the light emitting mechanism has a pivotal side and an aligning side respectively arranged at two opposite sides of the light output portion, and wherein the foldable optical engine further comprises a shaft, and the pivotal side of the projection mechanism is pivotally connected to the pivotal side of the light emitting mechanism through the shaft.
